(19) United States
(12) Patent Application Publication
(10) Pub. No.: US 2016/0310871 A1
(43) Pub. Date: Oct. 27, 2016

(54) SCAVENGING UNIT AND METHOD USING THE SAME

(71) Applicant: JOHNSON MATTHEY PUBLIC LIMITED COMPANY, London (GB)

(72) Inventors: Simon HOOPER, Hertfordshire (GB); Anna PARSONS, Macclesfield Cheshire (GB); Peter ROWE, Macclesfield Cheshire (GB)

(21) Appl. No.: 15/101,944

(22) PCT Filed: Oct. 1, 2014
(86) PCT No.: PCT/GB2014/052974

§ 371 Date: Jun. 6, 2016

(30) Foreign Application Priority Data
Dec. 4, 2013 (GB) 1321367.3

(51) Int. Cl. B01D 15/38; B01D 15/36; B01D 15/22

(52) U.S. Cl. CPC B01D 15/3828; B01D 15/22; B01D 15/36

(57) ABSTRACT

A scavenging unit includes a housing having at least two porous partitions positioned within the housing and defining there between a scavenging chamber to be filled with a scavenging medium. A first one of the at least two porous partitions is positioned proximate an upstream end of the housing and a second one of the at least two porous partitions is positioned proximate a downstream end of the housing. The housing includes a liquid inlet communicating with an upstream side of the first porous partition via an inlet chamber and a liquid outlet communicating with a downstream side of the second porous partition via an outlet chamber.

### BACKGROUND OF THE INVENTION

1. Field of the Invention

The invention relates generally to scavenging units and methods of using the same, and more particularly to such units and methods employed to remove metal species from a liquid.

2. Description of Related Art

It is often necessary to treat a liquid so as to reduce its content of metals. For example, in the pharmaceutical industry, active pharmaceutical ingredients (APIs) are often synthesized via routes involving one or more reaction steps that utilize a precious metal catalyst such as rhodium, platinum or palladium, or other base metal catalysts such as copper, nickel or iron. The resulting API product stream typically includes a relatively small amount of the metal from the catalyst, yet those amounts in some instances nevertheless significantly exceed regulatory limits.

One technique for removing such metals from reaction mixtures as described above is chelation or ion exchange by passing the metal-containing liquid over silica or polymer beads that bear functional groups designed to bind the target metal. For example, the QUADRAPURE® TU metal scavenger made by Johnson Matthey has the form of polystyrene beads bearing thiourea functional groups, which are effective to remove metal species such as Pd, Pt, Ru, Rh, Os, Au, Ag, Cu, Hg, Pb, Cd, Ni, Co, Fe, V and Zn from liquid streams.

It is desirable to provide systems in which such metal scavengers contact the liquid to be treated as fully as possible, and in which the scavenger need not be separated from the process liquid after contact has occurred. One effort to achieve those objectives is described in U.S. Pat. No. 8,480,896, in which liquid is fed centrally to the distal end of a scavenging filter, whereafter it is passed through a scavenging material in a direction opposite the main process flow, and thence led to an annular outer chamber from which the liquid exits the filter once again in the direction of the main process flow.

A need still exists, however, to provide improved scavenging units whose structure and operation facilitates the efficient and reproducible use of scavenging media on an industrial scale.

### SUMMARY OF THE INVENTION

In one aspect, the present invention relates to a scavenging unit comprising a housing having at least two porous partitions positioned within the housing and defining therebetween a scavenging chamber to be filled with a scavenging medium. A first one of the at least two porous partitions is positioned proximate an upstream end of the housing and a second one of the at least two porous partitions is positioned proximate a downstream end of the housing. The housing comprises a liquid inlet communicating with an upstream side of the first porous partition via an inlet chamber and a liquid outlet communicating with a downstream side of the second porous partition via an outlet chamber.

In preferred embodiments of the scavenging unit according to the present invention, a scavenging medium is positioned within the scavenging chamber.

In preferred embodiments of the scavenging unit according to the present invention, the scavenging medium comprises polymer beads bearing functional ligands that bind to a target metal species.

In preferred embodiments of the scavenging unit according to the present invention, the scavenging medium comprises silica beads bearing functional ligands that bind to a target metal species.

In preferred embodiments of the scavenging unit according to the present invention, the at least two porous partitions each has a pore size in a range from 10 to 80 microns, preferably 12 to 40 microns, and more preferably 15 to 30 microns.

In preferred embodiments of the scavenging unit according to the present invention, the at least two porous partitions each has a pore size at least two times smaller than a particle size of the scavenging medium, preferably at least four times smaller than a particle size of the scavenging medium, preferably at least seven times smaller than a particle size of the scavenging medium, and most preferably at least ten times smaller than a particle size of the scavenging medium.

In preferred embodiments of the scavenging unit according to the present invention, the housing comprises a central axis extending parallel to a flow direction of liquid through the housing, and wherein the at least two porous partitions each traverses the central axis.

In preferred embodiments of the scavenging unit according to the present invention, the housing is configured to conduct liquid from the liquid inlet to the liquid outlet in a unidirectional flow.

In preferred embodiments of the scavenging unit according to the present invention, the housing is elongated longitudinally, and the scavenging chamber has a transverse extent that is less than the distance between the first and last porous partitions.

In preferred embodiments of the scavenging unit according to the present invention, at least one of the at least two porous partitions is formed from a plurality of sintered stainless steel meshes.

In preferred embodiments of the scavenging unit according to the present invention, at least one of the at least two porous partitions is formed from sintered polyethylene.

In preferred embodiments of the scavenging unit according to the present invention, a third porous partition is positioned intermediate the first and second porous partitions, and dividing the scavenging chamber into first and second subchambers.

In preferred embodiments of the scavenging unit according to the present invention, the first subchamber is filled with a first scavenging medium and the second subchamber is filled with a second scavenging medium that differs from the first scavenging medium.

In preferred embodiments of the scavenging unit according to the present invention, the housing is cylindrical and the first and second porous partitions are circular discs whose outer diameter is approximately the same as an inner diameter of the housing.

In another aspect, the present invention relates to a method of scavenging metal species from a liquid feed, comprising passing the liquid feed through a scavenging unit comprising a housing having at least two porous partitions positioned within the housing and defining therebetween a scavenging chamber that is filled with a scavenging medium. A first one of the at least two porous partitions is positioned proximate an upstream end of the housing and a second one of the at least two porous partitions being positioned proximate a downstream end of the housing. The housing comprises a liquid inlet communicating with an upstream side of the first porous partition via an inlet chamber and a liquid outlet communicating with a downstream side of the second porous partition via an outlet chamber.

In preferred embodiments of the method according to the present invention, a pore size of the at least two porous partitions, a diameter of the liquid inlet and the liquid outlet, and a flow rate of the liquid feed are selected such that the liquid feed passes through the scavenging chamber as a plug flow that completely fills the scavenging chamber.

In preferred embodiments of the method according to the present invention, a pore size of the at least two porous partitions, a diameter of the liquid inlet and the liquid outlet, and a flow rate of the liquid feed are selected such a pressure drop exists between an upstream side of the first porous partition and a downstream side of the second porous partition, e.g., a pressure drop of at least 0.3 bar, and more preferably about 0.5 bar.

In preferred embodiments of the method according to the present invention, the at least two porous partitions each has a pore size in a range from 10 to 80 microns, preferably 12 to 40 microns, and more preferably 15 to 30 microns.

In preferred embodiments of the method according to the present invention, the at least two porous partitions each has a pore size at least two times smaller than a particle size of the scavenging medium, preferably at least four times smaller than a particle size of the scavenging medium, more preferably at least seven times smaller than a particle size of the scavenging medium, and most preferably at least ten times smaller than a particle size of the scavenging medium.

In preferred embodiments of the method according to the present invention, the method comprises a laminar flow regime, transient/turbulent flow regime or a turbulent flow regime.

### BRIEF DESCRIPTION OF THE DRAWINGS

Other objects, features and advantages of the invention will become more apparent after reading the following detailed description of preferred embodiments of the invention, given with reference to the accompanying drawings, in which:

FIG. 1 is an end view of a scavenging unit according to a first embodiment of the present invention;

FIG. 2 is a section view along the line II-II of FIG. 1;

FIG. 3 is an enlarged view of the detail III in FIG. 2;

FIG. 4 is an end view of a scavenging unit according to a second embodiment of the present invention;

FIG. 5 is a section view along the line V-V of FIG. 4;

FIG. 6 is an inner end view of one of the end closure elements shown in FIG. 5;

FIG. 7 is a section view along the line VII-VII in FIG. 6;

FIG. 8 is a longitudinal section through a scavenging unit according to a third embodiment of the present invention;

FIG. 9 is an inner end view of one of the end closure elements shown in FIG. 8

FIG. 10 is a longitudinal section through a scavenging unit according to a fourth embodiment of the present invention;

FIG. 11 is an inner end view of one of the end closure elements shown in FIG. 10;

FIG. 12 is an enlarged view of the detail XII in FIG. 10; and

FIG. 13 is a schematic layout of a scavenging system employing three scavenging units in a recirculation mode.

### DETAILED DESCRIPTION

In each of the embodiments described herein, the scavenging medium is preferably a material that is capable of binding metal species so as to remove them from the liquid to be treated. The metal species may be bound ionically, covalently, or a combination of both. When the binding is ionic, or more ionic than covalent, it may be possible to recover the metal species, if desired, by eluting the scavenging medium-metal species with a suitable solvent. When the binding is covalent, or is more covalent than ionic, then it may not be possible to recover the metal species by elution. In these instances, it may be possible to chemically reverse the binding, and/or burn off the scavenging medium to recover the metal.

The scavenging medium is preferably in a particulate form, a non-limiting example of such being beads or spheres. Still further, the scavenging media could instead take the form of non-spherical particles such as chips or other irregular shapes.

The scavenging medium may be selected from the scavenging medium range marketed under the trade name QUADRAPURE®, for example is QUADRAPURE® TU, which has the form of polystyrene beads bearing thiourea functional groups. The individual beads have a diameter of about 500 microns, and the size distribution of the beads is relatively monodisperse.

The scavenging media could alternatively take the form of silica beads having functional ligands grafted thereto, such as the scavenging material marketed by Johnson Matthey under the trademark QUADRASIL®.

The scavenging medium may be selected from those described in published International applications WO2001/098378 and WO2005/123971. WO2001/098378 describes examples of organic scavenger resins having 1,3-ketoester or 1,3-ketoamide pendant groups attached directly to a polymer support or attached to a polymer support through a linking group. The resins can be macroporous or microporous. A preferred resin of this type is one which is prepared from acetoacetoxyethyl methacrylate, styrene and divinylbenzene.

The published International application WO2005/123971 describes a scavenger support obtained by reacting a functionalised support comprising pendant groups selected from 1,3-ketoesters or 1,3-ketoamides or mixtures thereof attached to a support with an amine. The functionalised support may be organic (i.e. polymeric) or inorganic. When the functionalised support is an organic support it can be the same as for WO2001/098378 above.

When the functionalised support is inorganic it may be derived from naturally occurring inorganic materials or matrices or may be synthesised. Inorganic materials or matrices include glasses, silicas, aluminas, titanates and hybrid oxides thereof, graphites, oxides and zeolities. Certain inorganic supports may be derived from the reaction of inorganic materials or matrices with functionalising reagents either to give an inorganic support comprising pendant 1,3-ketoester or 1,3-ketoamide groups or to give a support with suitable functionalisation, for example pendant halo, hydroxy or amino groups to which the pendant 1,3-ketoester or 1,3-ketoamide groups can be attached directly or through a linking group.

Alternatively the scavenging medium could be based upon spherical polymer resins such as those marketed under the trade names DOWEX and LEWATIT, silica polyamine composite materials, including polymer coated silicas, such as those marketed by Purity Systems, Inc., biobased mesoporous materials derived from modified polysaccharides, such as those marketed under the trade name STARBON, phosphine oxide based polymer beads such as those marketed by Magpie Polymers, or ion-exchange resins such as polymeric resins having grafted functional groups.

In each of the embodiments described herein, the liquid to be treated by the scavenging unit can be any liquid containing one or more metal species, typically dissolved metals in ionic form, which it is desired to remove from the liquid to a significant degree. The liquids may for example be an aqueous solution containing metal species, an organic solvent containing metal species, as well as mixtures thereof, with it being understood that such mixtures could themselves be miscible or immiscible.

Applications of the scavenging units described herein include treatment of effluents in the context of pharmaceutical manufacturing. As noted above, the metal species which are scavenged could be metal contaminants from an API manufacturing route; however, metal contaminants may originate not only from catalysts used, but also or in the alternative as contaminants from e.g. metallic conduits or other equipment in which the process is taking place. Yet another application of the inventive scavenging units is in the ultrapurification of solvents, for example in pharmaceutical manufacturing processes.

The metals to be scavenged are preferably in solution in ionic form. Examples thereof include not only those mentioned hereinabove (i.e., Pd, Pt, Ru, Rh, Os, Au, Ag, Cu, Hg, Pb, Cd, Ni, Co, Fe, V or Zn, and preferably platinum group metals such as Pd, Pt, Ru, Rh or Os) but also metals whose known high toxicity requires that they be strictly limited, such as mercury, cadmium and selenium. The scavenging units of the present invention are likewise useful in other industries such as water treatment, refining, mining and chemical industries in general.

It will also be understood that the liquid to be treated may have a viscosity within a broad range. Indeed, a relatively high viscosity of the liquid to be treated may be advantageous in promoting the pressure drop across the porous partitions to be described more fully herein; however, the viscosity of the liquid to be treated should not be so great as to affect adversely the mechanical strength of the porous partitions, as might occur if the partitions were caused to bow under the pressure imparted by too viscous a liquid.

The scavenging units of the present invention can be designed to operate in a laminar flow or turbulent flow regime (including transient/turbulent flow regimes), by appropriate selection of the dimensions of the cartridge and the particle size and packing density of the scavenging medium, in relation to the physical properties of the liquid, as is known to those skilled in the art. Such flow regimes are conventionally characterized in terms of the

Reynolds number of the flow system, which, for a packed bed column, can be calculated using a characteristic length that takes into account both the column diameter of the enclosure and the particle diameter of the scavenging medium (see, e.g., A. N. S. Mak et al., “Axial dispersion in single phase flow in a pulsed column containing structured packing,” Chem. Eng. Sci. Vol. 46, No. 3, pp. 819-826 (1991)).

The various components of the scavenger cartridge are selected and designed to produce the desired pressure drop in combination with the particular scavenging medium to be used, and the liquid to be treated. Reference may be had in this regard to a predicted pressure drop as can be derived from the Ergun equation (see Ergun, S. (1952), Fluid flow through packed columns, Chemical Engineering Progress, 48(2), 89-94). The pressure drop may be measured by carrying out a small scale pilot to verify laboratory results before transferring the scavenging process on plant.

It will be appreciated that the scavenging units according to the present invention are not filters in design or operation. If it is found that the liquid to be scavenged contains solids, then a prefiltration step is typically required. If the liquid contains solids then provided it does not adversely affect the scavenging unit, then the solids may not need to be filtered. In most cases, however, it is contemplated that the liquids to be treated will not contain solids to any significant extent, with the scavenged metals being in solution in ionic form. Moreover, the scavenging chamber of the scavenging units is preferably longer than it is wide, so as to extend the flow path of the liquid through the scavenging medium, whereas a filter would typically be designed to maximize the area perpendicular to the flow direction.

Nor are the scavenging units according to the present invention suitable for use as liquid chromatography columns. In this respect, the stationary phase of a liquid chromatography column is typically packed with the stationary phase under high pressure. Liquid chromatography also concerns the separation, analysis and quantification of two or more compounds in a mixture, in which the mixture is usually dissolved in a solvent and forced under high pressure (such as about 300 bar) through the chromatography column. As chromatography involves the separation, analysis and quantification of compounds in a mixture, the liquid mixture to be separated is typically injected into the chromatography at intervals such that the compounds move through the column at different speeds. Those compounds having greater affinity for the stationary phase move more slowly through the column than those having less affinity. This speed differential results in the compounds being separated from one another as they pass through the column.

In contrast, the scavenging units according to the present invention are not packed under high pressure. Nor is it envisaged that the scavenging units are used at pressures similar to those utilized in chromatography columns. For example, the scavenging units of the present invention may be used at pressures of about 3 bar or less. Moreover, the scavenging units are for use in permanently removing an impurity (i.e. the metal species) from a bulk liquid. The liquid feed may be flowed continuously through the scavenger unit until the scavenging medium has reached its capacity for removing the metal species.

The flow rates through the scavenging units may be determined by gravity. Alternatively, the flow rates through the scavenging units may be substantially higher than liquid chromatography columns. For example, for a small scale laboratory scavenging unit (such as one comprising a scavenging chamber having a cross-section diameter of about 10 mm) the flow rate may be about 0.1 to about 20 litres/hour, such as about 1 to about 10 litres/hour, e.g. about 2 to about 5 litres/hour. For a large scale laboratory scavenging unit (such as one comprising a scavenging chamber having a cross-section diameter of about 50 mm) the flow rate may be about 10 to about 150 litres/hour, such as about 20 to about 100 litres/hour, e.g. about 30 to about 75 litres/hour. For a plant scale scavenging unit (such as one comprising a scavenging chamber having a cross-section diameter of about 350 mm) the flow rate may be about 150 to about 4500 litres/hour, such as about 500 to about 4000 litres/hour, e.g. about 1000 to about 3500 litres/hour or about 1500 to about 3000 litres/hour.

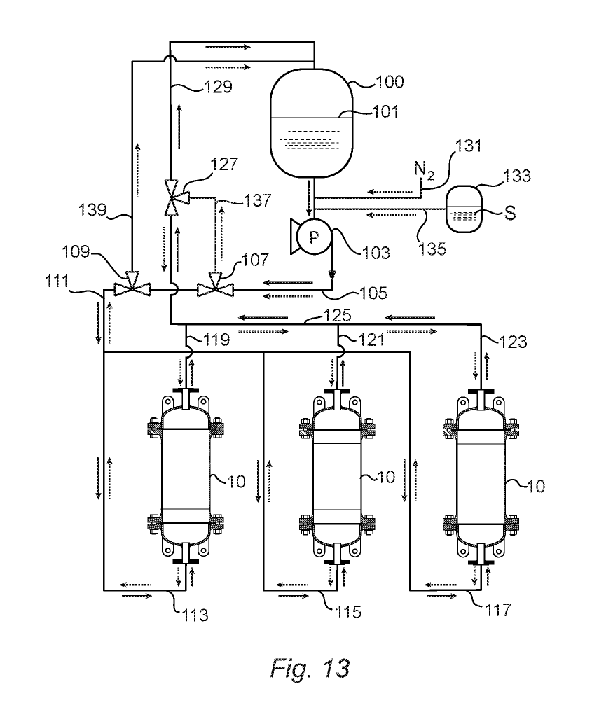

The scavenging units described herein are illustrated as being oriented horizontally, i.e., such that the primary flow direction is perpendicular to the downward gravitational force. The scavenging units can also be oriented vertically, as shown in FIG. 13, or even at an oblique angle if desired.

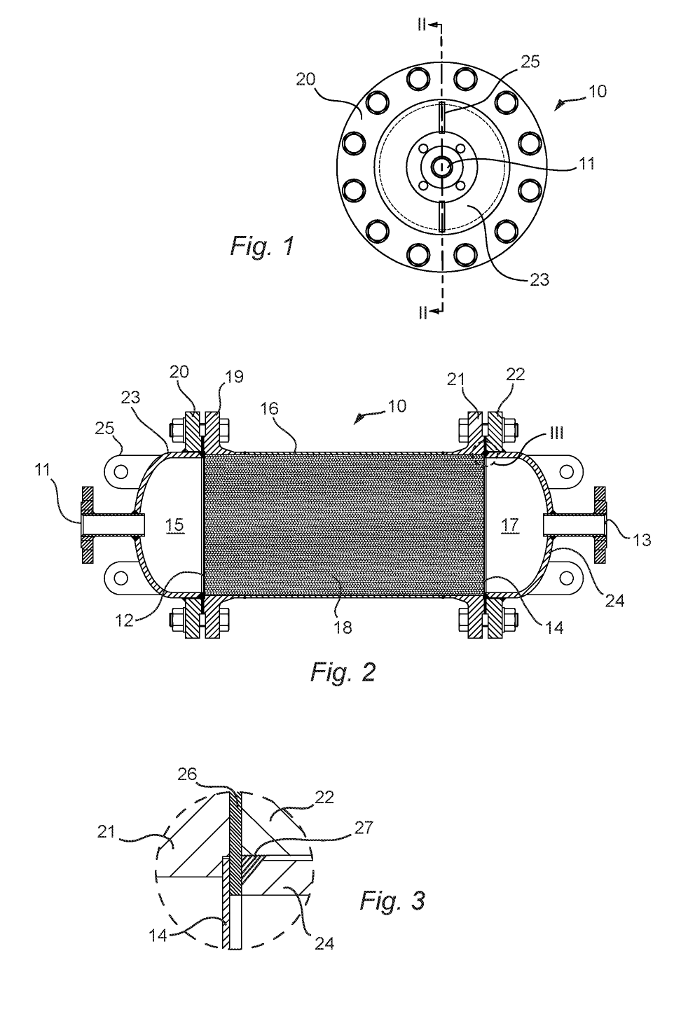

In FIGS. 1-3, the scavenging unit of the first embodiment comprises a housing 10 made of stainless steel. The central part 16 of the housing is cylindrical, and is extended at each end by a pair of flanges 19, 21 that are mirror images of one another. Upstream flange 19 is bolted to a mating flange 20 that is in turn welded to end cap 23, and, similarly, downstream flange 21 is bolted to a mating flange 22 that is in turn welded to end cap 24.

An upstream porous partition 12 is clamped between flanges 19, 20, and a downstream porous partition 14 is clamped between flanges 21, 22. Partitions 12, 14 define between them a scavenging chamber 18 that is filled with scavenging medium. The pairs of flanges 19, 21 permit the scavenging unit to be easily dismantled, cleaned, and, if desired, re-packed with fresh scavenging medium. The partitions 12, 14 and the other internal parts of the scavenging unit can also be inspected for damage or wear.

Partitions 12, 14 in this embodiment are a five-layer sintered wire cloth, such as that marketed by G. Bopp & Co. under the trade name POREMET™. The partitions have a pore size of about 20 microns in this embodiment, which corresponds to the finest layer of the five-layer composite, with the other four layers providing structural support and protection for the finest layer.

It will be noted that the porosity of partitions 12, 14 is therefore much smaller than would be necessary merely to confine the scavenging medium. The smaller porosity is selected so as to create a significant pressure drop in use between the upstream side of partition 12 and the downstream side of partition 14. For example, in the embodiment of FIGS. 1-3, the diameter of the scavenging chamber 18 is about eight times that of the inlet opening 11. Together with the partitions 12, 14 having a pore diameter of about 20 microns, this permits controlling flow conditions through the scavenging unit 10 so as to create a pressure drop of about 0.5 bar from the upstream side of partition 12 to the downstream side of partition 14. For example, the pressure within the inlet chamber 15 could be about 3 bar, and the pressure within the outlet chamber 17 could be about 2.5 bar.

Such a pressure drop serves to ensure that the liquid will fill the scavenging chamber 18 completely and proceed through that chamber as a plug flow, thereby achieving maximum contact between the liquid to be treated and the scavenging media. The flow through the scavenging chamber 18 is thus distributed homogeneously across the diameter of the housing so as to maximize utilization of the scavenger. The flow through the scavenging chamber 18 may be a laminar flow regime. Alternatively, the flow through the scavenging chamber 18 be in the turbulent or transient/turbulent regime. At the same time, the partitions 12, 14 ensure that the scavenging media will be reliably confined within the scavenging chamber 18, so that no post treatment separation of the scavenging media from the treated liquid will be necessary.

In the detail of FIG. 3, it can be seen that the partition 14 is clamped between flange 21 on the upstream side and the assembly of flange 22 and end cap 24 on the downstream side, which latter components are welded together at 27. The mounting of the upstream partition 12 is essentially a mirror image of that shown in FIG. 3. Also shown in FIG. 3 is a gasket 26 that ensures that the liquid passing through the scavenging unit will flow only through the porous partition 14.

Partitions 12, 14 are removable in this embodiment, which facilitates recovery of the captured metal species from the scavenging media once it has become fully loaded with the metal species. Alternatively, it may be preferable to weld partitions 12 and/or partition 14 in place for certain applications, or to mount them as a force fit within housing 10, rather than by clamping.

Partitions 12, 14 could instead also be mounted within their respective end caps 23, 24, closer to the respective inlet and outlet 11, 13. Such an alternative mounting would reduce the volume of inlet and outlet chambers 15, 17, while increasing the volume of the scavenging chamber 16 so as to accommodate any swelling of the scavenging media 18 as might occur during use of the unit.

The end caps 23, 24 of housing 10 are also equipped with lifting lugs 25, as, depending upon the application, the scavenging units according to the present invention when loaded with the scavenger could be so large as to weigh as much as 100 kg or more.

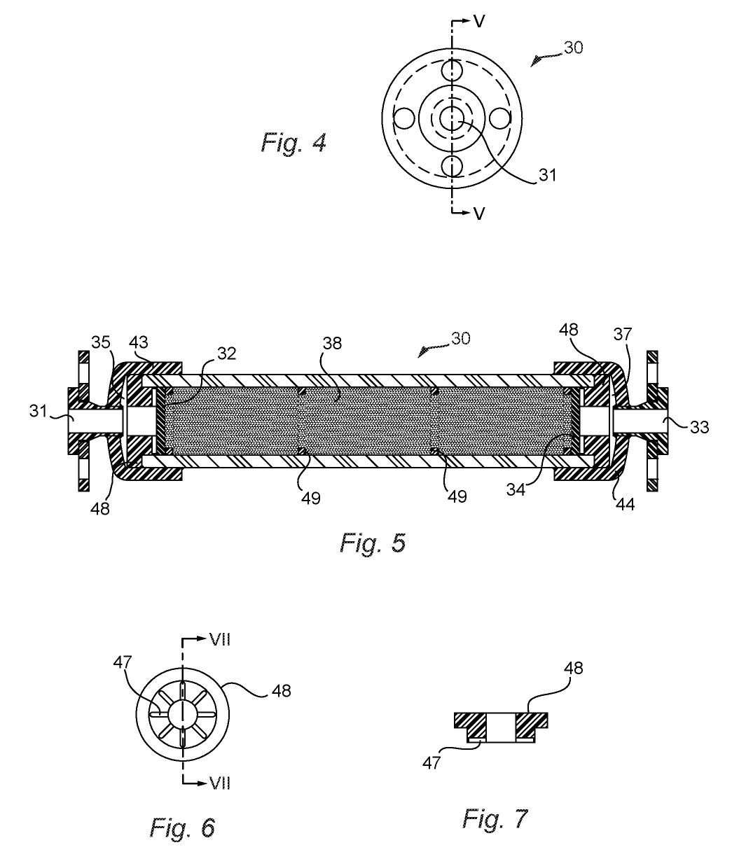

Turning now to FIGS. 4-7, in a second embodiment of a scavenging unit according to the present invention, the housing 30 is formed from a plastic material, such as polypropylene. Other suitable materials for the housing include carbon-fiber reinforced composites, and metals having an internal coating of chemically resistant or food-grade plastic.

In this embodiment, the upstream porous partition 32 and the downstream porous partition 34 are each formed of a sintered thermoplastic material such as sintered polyethylene and/or sintered polypropylene, although again a variety of other materials could also be used. Partitions 32, 34 are force fit within the main body of housing 30.

In addition to inlet opening 31, inlet chamber 35, end cap 43, outlet opening 33, outlet chamber 37 and end cap 44, the present embodiment also features a series of four rings 49 that are force fit or welded within the main body of housing 30. These rings 49 are considered beneficial to prevent boundary effects and to assist in controlling the flow of the liquid to be treated through the scavenging media, especially at relatively lower flow rates; however, the use of such rings 49 is optional.

This embodiment also incorporates two end closure elements 48 each welded to a respective opposite end of the main body of housing 30. The inward faces of these end closure elements comprises radial distribution channels 47 to promote a uniform application of the liquid to be treated across the face of the partitions 32, 34.

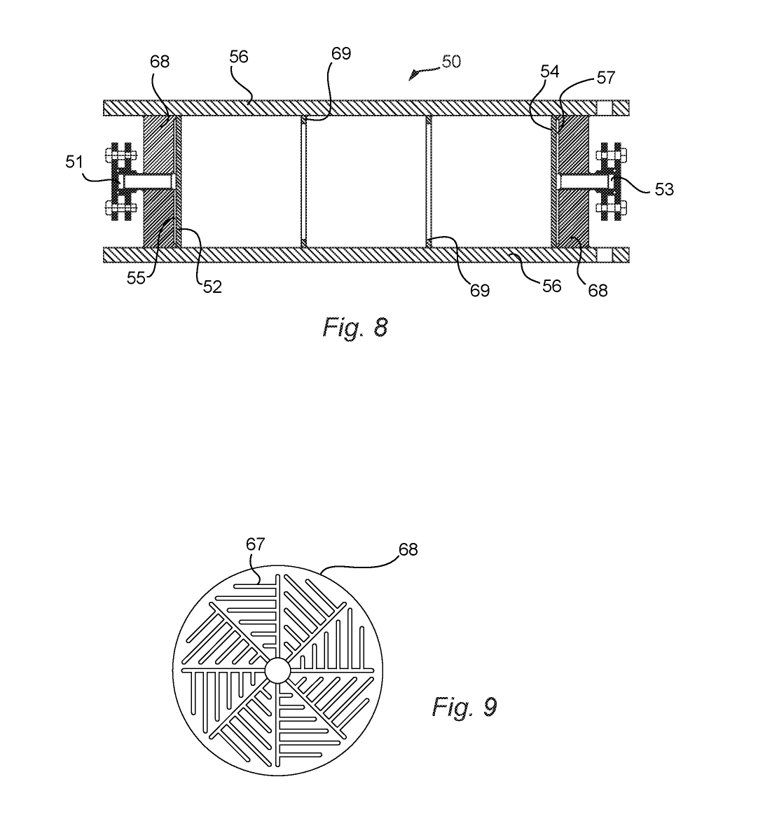

FIGS. 8 and 9 show a third embodiment of a scavenging unit according to the present invention, in which the housing 50 is formed mainly from a cylindrical pipe 56 formed from a plastic material, such as polypropylene. Other suitable materials for the housing again include carbon-fiber reinforced composites, and metals having an internal coating of chemically resistant or food-grade plastic.

In this embodiment, the upstream porous partition 52 and the downstream porous partition 54 are each formed of sintered thermoplastic materials such as sintered polyethylene and/or sintered polypropylene, although again a variety of other materials could also be used. Partitions 52, 54 are force fit within the main body 56 of housing 50.

The present embodiment also features a pair of rings 69 that are force fit or welded within the main body 56 of housing 50, for the same purpose as is discussed in connection with the rings 49 of the embodiment of FIGS. 5-7. The use of such rings 69 is optional.

The end closure elements 68 of this embodiment also serve as end caps, and each is welded to a respective opposite end of the main body 56 of housing 50. The inward faces of these end closure elements comprises radial distribution channels 67 to promote a uniform application of the liquid to be treated across the face of the partitions 52, 54. It will be noted that in this embodiment the inlet and outlet chambers are constituted entirely by the volume of these distribution channels 67 on closure elements 68.

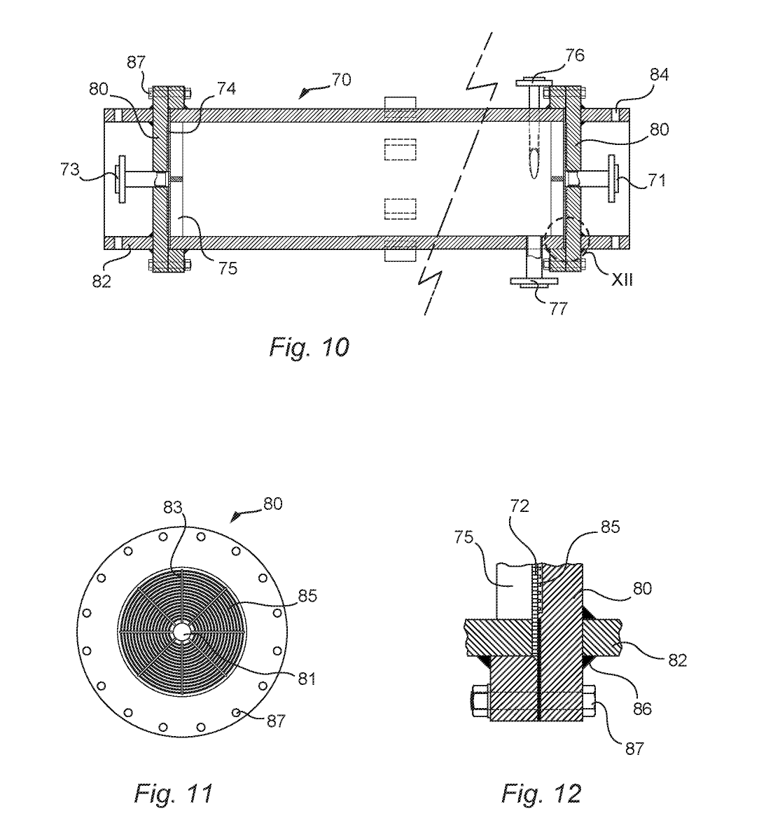

In the embodiment of FIGS. 10-12, housing 70 is again formed mainly from a cylindrical pipe formed from a plastic material, such as polypropylene. The chamber is shown interrupted in FIG. 10, as in practice the length of the chamber containing scavenging medium is preferably about five times the diameter of the chamber.

The flow direction in this embodiment is from the right to the left relative to the drawing, such that an upstream porous partition 72 is positioned downstream of inlet opening 71, and a downstream porous partition 74 is positioned upstream of outlet opening 73. In this embodiment, the upstream porous partition 72 and the downstream porous partition 74 are again each formed of sintered thermoplastic materials such as sintered polyethylene and/or sintered polypropylene, although again a variety of other materials could also be used. Partitions 72, 74 are clamped between end plates 80 and the respective ends of housing 70.

As shown in FIG. 11, the inner face of each end plate 80 comprises channels 83 that extend radially from a central opening 81 that is aligned with the inlet 71 or outlet 73 of the scavenging unit. Channels 83 might for example have a depth and width that are both about 5 mm. Channels 83 distribute liquid into a series of concentric annular channels 85 that are also formed on the inner face of end plate 80. Channels 85 might for example have a depth and width that are both about 3 mm. As in the preceding embodiment, channels 83, 85 promote a uniform application of the liquid to be treated across the face of the partitions 72, 74. It will be noted that in this embodiment the inlet and outlet chambers are again constituted entirely by the volume of these distribution channels 83, 85 on partitions 72, 74.

Annular flanges 82 are welded to the outer faces of end plates 80, and are provided with radially extending bores 84 to aid in moving and positioning the unit. The unit is also provided in this embodiment with nozzles 76 and 77 that open into the scavenging medium chamber from the side of the unit. Nozzles 76, 77 may permit supplemental feed of the liquid to be treated into the chamber, as well as the fluids used to regenerate the scavenging medium, and also permit monitoring of the process. The nozzles 76, 77 may also permit the draining out of wet spent scavenger medium e.g. beads which may flow as liquid, and washing of the chamber 70. The end plate 80 and porous partition 72 and/or the other end plate 80 and porous partition 74 may then be removed when the chamber 70 is empty and clean, and is ready to be recharged with fresh scavenging medium.

As can be seen in FIG. 12, the porous partition 72 is clamped between the end plate 80 and the end of chamber 70, by the series of bolts 87 that connects the end plate 80 to chamber 70. The end plate 80 is welded at 86 to the annular flange 82.

In each of the foregoing embodiments, the number of layers making up each of the porous partitions is immaterial, provided that the partition has sufficient strength to withstand the pressure applied to it without significant bowing. For a given porous material, the larger the diameter of the partition, the more likely that one or more reinforcing layers will be needed. Such reinforcing layers could be disc-shaped layers whose openings are substantially larger than those of the porous partition, or they could for example be of a cruciform configuration joined by an annular rim. The reinforcing layer or layers, if present, will be on the downstream side of the porous partition, as any bowing of the partition would occur in that direction. The porous partition and any reinforcing layers may be welded together to form a unitary structure, or they may be clamped together when mounted within the surrounding structure of the scavenging unit.

The scavenging units as described herein may be operated in a single pass mode or may be operated such that the liquid to be treated is recirculated through the scavenging unit any desired number of times. In FIG. 13, the layout of a scavenging system is shown that utilizes three of the scavenging units 10 described above in connection with FIGS. 1-3.

The liquid 101 to be treated is supplied from a container 100 of the same, with the aid of a pump 103. In FIG. 13, the arrows in solid line designate the flow of the liquid 101 to be treated, whereas the arrows in broken line designate the flow of the fluids used to purge and/or regenerate the scavenging unit, as described below.

From the pump 103, liquid 101 flows through conduit 105 to a first three-way valve 107, through which it passes in the horizontal direction of FIG. 13 to a second three-way valve 109. The liquid 101 is then fed to conduit 111, which branches into three conduits 113, 115, 117, each of which communicates with the inlet of a corresponding scavenging unit 10. The scavenging units 10 are thus positioned vertically in this embodiment with their inlets at the lower end thereof, such that the liquid 101 to be treated flows upwardly through the scavenging medium. Such an arrangement can be advantageous as regards the initial degassing of the scavenging units 10, as well as for urging the liquid 101 to fill any voids within the scavenging medium.

The treated liquid 101 flows out of the scavenging units 10 through conduits 119, 121, 123, which feed into a common conduit 125. The combined outlet flows in conduit 125 are then fed through a third three-way valve 127 to conduit 129, which returns the treated liquid 101 to the container 100. Liquid 101 may thereafter be treated one or more further times by repeating the process described above, or may instead be removed from container 100 when the processing is complete.

The system of FIG. 13 also permits purging and/or washing and regenerating of the scavenging units 10. To that end, a supply of gaseous nitrogen N₂ communicates with conduit 131, whereas a supply of a solvent S is provided in a container 133 that communicates with conduit 135. When it is desired to purge or regenerate the scavenging medium, nitrogen and/or solvent S are fed through one or both of the conduits 131, 135, as indicated by the broken line arrows, to pump 103. The nitrogen and/or solvent S then passes through conduit 105 to the first three-way valve 107, which in this mode is set so as to direct the flow of nitrogen and/or solvent S in the upward direction of FIG. 13 to the third three-way valve 127. Valve 127 is in turn set in this operating mode to direct the flow of nitrogen and/or solvent S in the downward direction of FIG. 13 into the conduit 125.

The flow of nitrogen and/or solvent S is thereby introduced into the conduits 119, 121, 123 and caused to flow through the scavenging units 10 in the top-to-bottom direction, opposite the flow of liquid 101 as described in the preceding operating mode. The flow of nitrogen and/or solvent S exits the scavenging units 10 at their bottom ends, into conduits 113, 115, 117, and is recombined in the conduit 111. Lastly, the second three-way valve 109 is in this operating mode set so as to direct the flow of nitrogen and/or solvent S into conduit 139, from which the nitrogen and/or solvent S may be routed to the container 100 if the operating sequence is to be repeated.

It will be understood that the foregoing description and specific embodiments shown herein are merely illustrative of the invention and the principles thereof, and that modifications and additions may be easily made by those skilled in the art without departing from the spirit and scope of the invention, which is therefore understood to be limited only by the scope of the appended claims.

1. A scavenging unit comprising a housing having at least two porous partitions positioned within said housing and defining there between a scavenging chamber to be filled with a scavenging medium, a first one of said at least two porous partitions being positioned proximate an upstream end of said housing and a second one of said at least two porous partitions being positioned proximate a downstream end of said housing, said housing comprising a liquid inlet communicating with an upstream side of said first porous partition via an inlet chamber and a liquid outlet communicating with a downstream side of said second porous partition via an outlet chamber.

2. The scavenging unit according to claim 1, further comprising a scavenging medium positioned within said scavenging chamber.

3. The scavenging unit according to claim 2, wherein said scavenging medium comprises polymer beads bearing functional ligands that bind to a target metal species.

4. The scavenging unit according to claim 2, wherein said scavenging medium comprises silica beads bearing functional ligands that bind to a target metal species.

5. The scavenging unit according to claim 1, wherein said at least two porous partitions each has a pore size in a range from 10 to 80 microns, preferably 12 to 40 microns, and more preferably 15 to 30 microns.

6. The scavenging unit according to claim 1, wherein said at least two porous partitions each has a pore size at least two times smaller than a particle size of said scavenging medium, preferably at least four times smaller than a particle size of said scavenging medium, more preferably at least seven times smaller than a particle size of said scavenging medium, and most preferably at least ten times smaller than a particle size of said scavenging medium.

7. The scavenging unit according to claim 1, wherein said housing comprises a central axis extending parallel to a flow direction of liquid through said housing, and wherein said at least two porous partitions each traverses said central axis.

8. The scavenging unit according to claim 1, wherein said housing is configured to conduct liquid from said liquid inlet to said liquid outlet in a unidirectional flow.

9. The scavenging unit according to claim 1, wherein said housing is elongated longitudinally, and wherein said scavenging chamber has a transverse extent that is less than the distance between the first and last porous partitions.

10. The scavenging unit according to claim 1, wherein at least one of said at least two porous partitions is formed from a plurality of sintered stainless steel meshes.

11. The scavenging unit according to claim 1, wherein at least one of said at least two porous partitions is formed from sintered polyethylene.

12. The scavenging unit according to claim 1, further comprising a third porous partition positioned intermediate said first and second porous partitions, and dividing said scavenging chamber into first and second subchambers.

13. The scavenging unit according to claim 12, said first subchamber is filled with a first scavenging medium and said second subchamber is filled with a second scavenging medium that differs from said first scavenging medium.

14. The scavenging unit according to claim 1, wherein said housing is cylindrical and wherein said first and second porous partitions are circular discs whose outer diameter is approximately the same as an inner diameter of said housing.

15. The scavenging unit according to claim 1, wherein each of said at least two porous partitions is composed of at least two layers.

16. A method of scavenging metal species from a liquid feed, comprising passing the liquid feed through a scavenging unit comprising a housing having at least two porous partitions positioned within said housing and defining there between a scavenging chamber that is filled with a scavenging medium, a first one of said at least two porous partitions being positioned proximate an upstream end of said housing and a second one of said at least two porous partitions being positioned proximate a downstream end of said housing, said housing comprising a liquid inlet communicating with an upstream side of said first porous partition via an inlet chamber and a liquid outlet communicating with a downstream side of said second porous partition via an outlet chamber.

17. The method according to claim 16, wherein a pore size of said at least two porous partitions, a diameter of said liquid inlet and said liquid outlet, and a flow rate of said liquid feed are selected such that said liquid feed passes through said scavenging chamber as a plug flow that completely fills said scavenging chamber.

18. The method according to claim 16, wherein a pore size of said at least two porous partitions, a diameter of said liquid inlet and said liquid outlet, and a flow rate of said liquid feed are selected such a pressure drop of at least 0.3 bar, and preferably about 0.5 bar, exists between an upstream side of said first porous partition and a downstream side of said second porous partition.

19. The method according to claim 16, wherein said at least two porous partitions each has a pore size in a range from 10 to 80 microns, preferably 12 to 40 microns, and more preferably 15 to 30 microns.

20. The method according to claim 16, wherein said at least two porous partitions each has a pore size at least two times smaller than a particle size of said scavenging medium, preferably at least four times smaller than a particle size of said scavenging medium, more preferably at least seven times smaller than a particle size of said scavenging medium, and most preferably at least ten times smaller than a particle size of said scavenging medium.

21. The method according to claim 16, wherein the method comprises a laminar flow regime, transient/turbulent flow regime or a turbulent flow regime.
